(19) United States
(12) Patent Application Publication
(10) Pub. No.: US 2015/0370449 A1
(43) Pub. Date: Dec. 24, 2015

(54) TERMINAL AND METHOD FOR CONTROLLING TERMINAL WITH TOUCHSCREEN

(71) Applicant: DONGGUAN GOLDEX COMMUNICATION TECHNOLOGY CO., LTD., Dongguan, Guangdong (CN)

(72) Inventor: Pan Huang, Dongguan (CN)

(73) Assignee: Dongguan Goldex Communication Technology Co., Ltd., Dongguan (CN)

(21) Appl. No.: 14/765,758

(22) PCT Filed: Jan. 13, 2014
(86) PCT No.: PCT/CN2014/070509

§ 371 Date: Aug. 4, 2015

(30) Foreign Application Priority Data
Feb. 5, 2013 (CN) 201310046058.5

(51) Int. Cl. G06F 3/0481; G06F 3/0488; G06F 3/0482; G06F 3/041; G06F 3/0484

(52) U.S. Cl. CPC G06F 3/04817; G06F 3/041; G06F 3/04842; G06F 3/0482; G06F 3/0488

(57) ABSTRACT

Provided are a terminal and method for controlling a terminal with a touchscreen. The method includes: obtaining a contact range of an operation performed by a user on a touchscreen and icons at least a part of each of which falls within the contact range; determining whether or not the number of the obtained icons is more than one; if the number of the obtained icons is more than one, then selecting objects to be amplified from a display interface displayed on the touchscreen based on the contact range and amplifying the objects to generate an amplification region; and when it is detected that the user triggers one icon in the amplification region, executing an instruction corresponding to the icon. The above-mentioned method can reduce the complexity of the manual operation of a user, and improve the flexibility of a touchscreen device.

### CROSS REFERENCE TO RELATED APPLICATIONS

This application is a continuing application of PCT Patent Application No. PCT/CN2014/070509, entitled “TOUCHSCREEN CONTROL METHOD AND DEVICE”, filed on Jan. 13, 2014, which claims priority to Chinese Patent Application No. 201310046058.5, filed on Feb. 5, 2013, both of which are hereby incorporated in its entireties by reference.

### FIELD OF THE TECHNICAL

The present disclosure relates to electronic technology field, and more particularly to a terminal and method for controlling a terminal with a touchscreen.

### BACKGROUND

With enhancement of performance of touchscreens, integration of chips, and manufacturing process, mobile devices, such as smart phones and tablet computers for example, become more and more popular in people's daily life. Mobile terminal devices having touchscreens provide users with convenient and direct use. However, due to limitation of device size and influence brought by simple industrial design, input operation space of the touchscreens are generally smaller. Especially for mobile phones having touchscreens, during use, false touch occurs due to the size of icons is too small and contact area of a finger is too large. A solution is proposed to solve the problem brought by false touch. When it is detected that a user performs a specified gesture on the touchscreen, the operation interface is amplified to a certain proportion. Or when it is detected that the user's finger touches the touchscreen, the image-text within a certain range with the touch position of the user's finger as the center are amplified and displayed on the displayed interface displayed on the touchscreen. Like the movement of a trackball, the amplified image-text varies with the movement of the touch position of the user's finger.

The first method described above can decrease false touch by amplifying icons. However, after finishing input, the user still needs to perform a gesture to return the display interface to its normal proportion, which is trouble. Especially for applications without zooming function, the method described above cannot be used. The second method described above increase the accuracy of operation. However, it needs the user to repeatedly perform operations to move the finger to a specified position, the process is complicated, and user's experience is affected.

### SUMMARY

The embodiments of the present disclosure provide a terminal and method for controlling a terminal with a touchscreen, which can provide a user with a better operation interface and increase the accuracy of user's operation when it is detected that there is more than one desktop icon covered by a contact range of an operation performed by a user on a touchscreen.

In detail, the method for controlling a terminal with a touchscreen provided by the embodiments of the present invention includes the following steps.

Obtaining a contact range of an operation performed by a user on a touchscreen and icons at least a part of each of which falls within the contact range.

Determining whether or not the number of the obtained icons is more than one.

Selecting objects to be amplified from a display interface displayed on the touchscreen based on the contact range and amplifying the selected objects to generate an amplification region if the number of the obtained icons is more than one.

Executing an instruction corresponding to one icon when it is detected that the user triggers the one icon in the amplification region.

Correspondingly, the terminal provided by the embodiments of the present invention includes the following units.

An obtaining unit is configured to obtain a contact range of an operation performed by a user on a touchscreen and icons at least a part of each of which falls within the contact range.

A determining unit is configured to determine whether or not the number of the obtained icons is more than one.

A display unit is configured to select objects to be amplified from a displayed interface displayed on the touchscreen based on the contact range and amplify the selected objects to generate an amplification region and display the amplification region if the number of the obtained icons is more than one.

A detecting unit is configured to detect and obtain a further operation performed by the user on the display interface.

An executing unit is configured to execute an instruction corresponding to one icon when the detecting unit detects that the user triggers the one icon in the amplification region.

Furthermore, the terminal provided by the embodiments of the present invention includes a touchscreen, a storage unit storing a plurality of computer-readable program codes, and a processor electrically connected to the touchscreen and the storage unit and configured to execute the plurality of computer-readable program codes to: obtain a contact range of an operation performed by a user on the touchscreen and icons at least a part of each of which falls within the contact range, determine whether or not the number of the obtained icons is more than one, select objects to be amplified from a display interface displayed on the touchscreen based on the contact range and amplify the selected objects to generate an amplification region if the number of the obtained icons is more than one, and execute an instruction corresponding to one icon when it is detected that the user triggers the one icon in the amplification region.

The embodiments of the present invention provide a terminal and a method for controlling a terminal with a touchscreen, which can generate an amplification region on the display interface when it is detected that there is more than one icon covered by the coverage range of an operation performed by a user on a touchscreen, to allow the user to directly perform a touch operation on the icon in the amplification region, provide a better operation interface, and increase the accuracy of user's operation.

### BRIEF DESCRIPTION OF THE DRAWINGS

To better illustrate the technical solution of embodiments of the present invention, the following descriptions will briefly illustrate the accompanying drawings described in the embodiments. Obviously, the following described accompanying drawings are some embodiments of the present invention. Those skilled in the art can obtain other accompanying drawings according to the described accompanying drawings without creative work.

FIG. 1 is a flowchart of a method for controlling a terminal with a touchscreen in accordance with an embodiment of the present invention.

FIG. 2 is a schematic view of a structure of a terminal in accordance with an exemplary embodiment of the present invention.

FIG. 3 is a schematic view of a structure of a terminal in accordance with another exemplary embodiment of the present invention.

FIG. 4 is a flowchart of a terminal in accordance with an exemplary embodiment of the present invention.

FIG. 5 is a flowchart of a terminal in accordance with another exemplary embodiment of the present invention.

FIG. 6 is a flowchart of a terminal in accordance with another exemplary embodiment of the present invention.

FIG. 7 is a schematic view of a display screen of a terminal in accordance with an exemplary embodiment of the present invention.

FIG. 8 is a schematic view showing amplification effect of icons of a terminal in accordance with an exemplary embodiment of the present invention.

FIG. 9 is a schematic view showing how to determine icons to be amplified in accordance with an exemplary embodiment of the present invention.

FIG. 10 is a schematic view showing amplification effect of icons of a terminal in accordance with another exemplary embodiment of the present invention.

FIG. 11 is a schematic view showing amplification effect of icons of a terminal in accordance with another exemplary embodiment of the present invention.

FIG. 12 is a schematic view showing how to determine a proportion of coverage area within a contact range of a user's finger in accordance with an exemplary embodiment of the present invention.

FIG. 13 is a schematic view showing an effect generated by a terminal automatically selecting a default execution instruction in accordance with an exemplary embodiment of the present invention.

FIG. 14 is a schematic view showing an input text generated based on a terminal in accordance with an exemplary embodiment of the present invention.

FIG. 15 is a schematic view showing an amplified icon of an input text generated based on a terminal in accordance with an exemplary embodiment of the present invention.

FIG. 16 is a schematic view showing an input text generated based on a terminal in accordance with an exemplary embodiment of the present invention.

FIG. 17 is a schematic view showing an input text generated based on a terminal in accordance with another exemplary embodiment of the present invention.

FIG. 18 is a schematic view showing an input text generated based on a terminal in accordance with another exemplary embodiment of the present invention.

FIG. 19 is a schematic view showing an input text generated based on a terminal in accordance with another exemplary embodiment of the present invention.

FIG. 20 is a schematic diagram of a terminal in accordance with an exemplary embodiment of the present invention.

### DETAILED DESCRIPTION OF ILLUSTRATED EMBODIMENTS

The technical solution of embodiments of the present invention will be described clearly and completely in combination with the accompanying drawings of the embodiments of the present invention. Obviously, the described embodiments are a part of embodiments of the present invention, and not all of the embodiments. According to the embodiments of the present invention, other embodiments obtained by those skilled in the art without creative work all fall within the protection scope of the present invention.

A method for controlling a terminal with a touchscreen provided by an embodiment of the present invention may include: obtaining a contact range of an operation performed by a user on a touchscreen and icons at least a part of each of which falls within the contact range; determining whether the number of the obtained icons is more than one; if the number of the obtained icons is more than one, then selecting objects to be amplified from a display interface displayed on the touchscreen based on the contact range and amplifying the selected objects to generate an amplification region; and when it is detected that the user triggers one icon in the amplification region, executing an instruction corresponding to the icon. In the embodiment of the present invention, when it is detected that there are a number of icons at least a part of each of which falls within the user's contact range, an amplification region is generated on the display interface, allowing the user to directly perform a touch operation on the amplified icon in the amplification region, and allowing the user to directly perform a touch operation in the amplification region. Therefore, the embodiment of the present invention may provide the user with a better display interface, and reduce the complexity of the manual operation of the user.

In detail, in the embodiment of the present invention, selecting objects to be amplified may include: selecting all the icons at least a part of each of which falls within the contact range; or when the center of the contact range falls within the peripheral region of one icon, selecting the first icon adjacent to the center of the contact range and on a straight line connecting the center of the icon to the center of the contact range; or selecting the icons at least a part of each of which falls within a second specified range the center of which is the same as that of the contact range; or selecting a third specified range the center of which is the same as that of the contact range. The embodiment of the present invention provides the user with the amplified icons which are displayed in the amplification region and selected based on the contact range of the user, thus it has flexibility.

The following will specifically illustrate the technical solution of the embodiment of the present invention in combination with the accompanying drawings and detailed description of the illustrated embodiment.

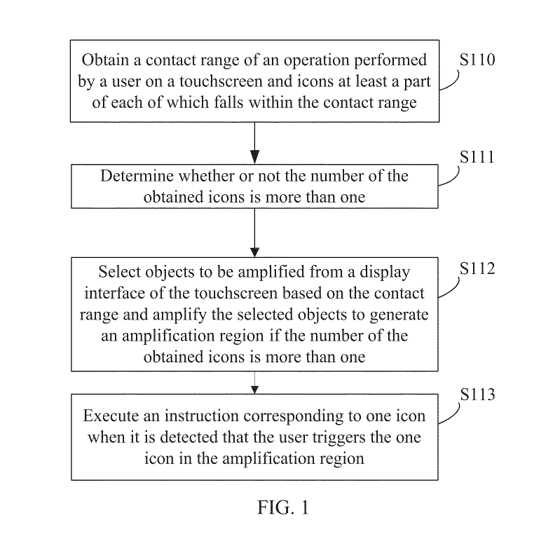

FIG. 1 is a flowchart of a method for controlling a terminal with a touchscreen in an embodiment. The embodiment includes the following steps.

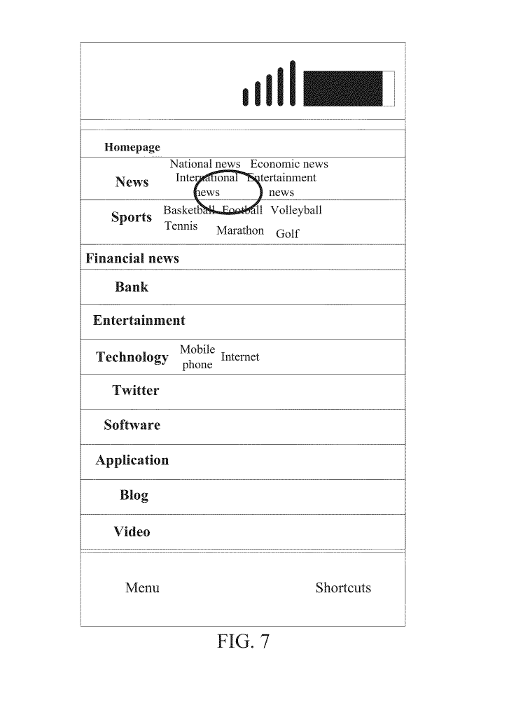

In step S110, obtaining a contact range of an operation performed by a user on a touchscreen, and obtaining icons at least a part of each of which falls within the contact range. Wherein, the contact range referred in this step may include the coverage range of a finger when the user performs an operation on the displayed interface displayed on the touchscreen, or the first specified range the center of which is the same as that of the coverage range. The terminal computes the center of the coverage range referred in this step according to the coverage range of the user. The terminal determines the contact range according to the coordinates of the center of the coverage range. For example, as shown in FIG. 7, the terminal may directly determine the coverage range of the user's finger on the touchscreen as the contact range of the user, or obtain points or a set of points covered by the coverage range which falls within the coordinate system of the touchscreen, compute the coordinates of the center of the coverage range according to the coordinates of the points or the set of points, and submit the coordinates of the center to the terminal. The terminal may determine the range the distance between any point within which and the center of the coverage range of the user's finger on the touchscreen is equal to or less than 0.3 cm as the contact range of the user. In step S110 of the embodiment of the present invention, the contact range of the user may be specifically set according to actual usage condition. Additionally, the icons at least a part of each of which falls within the contact range include all the icons covered by the contact range. In detail, on the display screen of the terminal shown in FIG. 7, the icons on the display interface displayed on the touchscreen covered by the contact range include the icons of international news, entertainment news, basketball, and football, thus in this step four icons are obtained.

In step S111, determining whether the number of the obtained icons is more than one. For the example described in step S110, the number of the icons obtained by the terminal is four, thus the terminal determines that the number of the obtained icons is more than one. Wherein, if the number of the icon obtained in this step is one, the terminal directly executes the execution instruction corresponding to the icon. If the number of the icon obtained in this step is less than one, the terminal does not make any response.

In step S112, if the number of the obtained icons is more than one, then selecting objects to be amplified from the display interface displayed on the touchscreen based on the contact range, and amplifying the selected objects to generate an amplification region.

In detail, in step S111, when it is determined that the number of the icons obtained by the terminal is more than one, the icons, or a part of or all of the display interface selected from the display interface displayed on the touchscreen is amplified according to a specified proportion and displayed in the amplification region of the display interface. Wherein, selecting objects to be amplified may include: selecting all the icons at least a part of each of which falls within the contact range; or when the center of the contact range falls within the peripheral region of one icon, selecting the first icon adjacent to the center of the contact range and on a straight line connecting the center of the one icon to the center of the contact range; or selecting the icons at least a part of each of which falls within a second specified range the center of which is the same as that of the contact range; or selecting a third specified range the center of which is the same as that of the contact range. Additionally, when the selected icons are amplified according to a specified proportion, the amplification proportion may be a default value, or may be specifically set. Additionally, the amplification region of the display interface may be on a position near the touch position of the user, or the display interface may be directly amplified with the current touch position as the center. The area of the amplification region may be set to just include all the amplified icons, or may be adjusted according to specific condition.

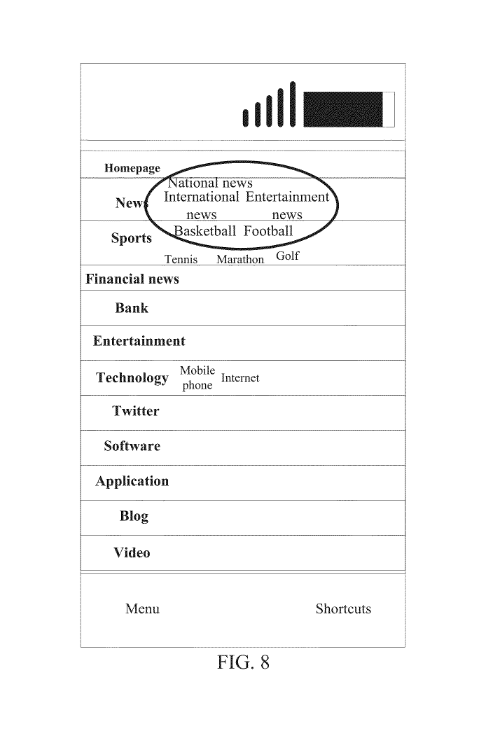

In detail, when the terminal selects all the icons at least a part of each of which falls within the contact range as the objects to be amplified, the terminal directly amplifies all the icons obtained in step S110 in the amplification region. For example, as shown in FIG. 7, after step S110 is executed, the terminal obtains the four icons of international news, entertainment news, basketball, and football, and the terminal directly amplifies the four icons in the amplification region. The amplification effect is shown in FIG. 8. Above the contact range of the user, the terminal generates the amplification region, and displays all the icons obtained in step S110 in the amplification region. All of these icons may be directly triggered in the amplification region, and corresponding instructions are executed.

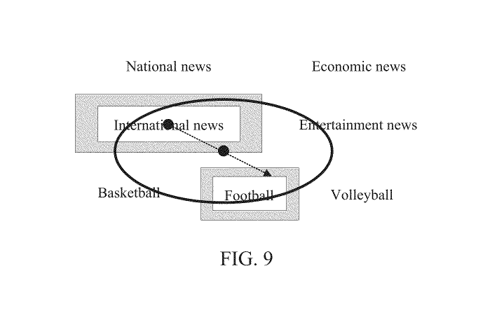

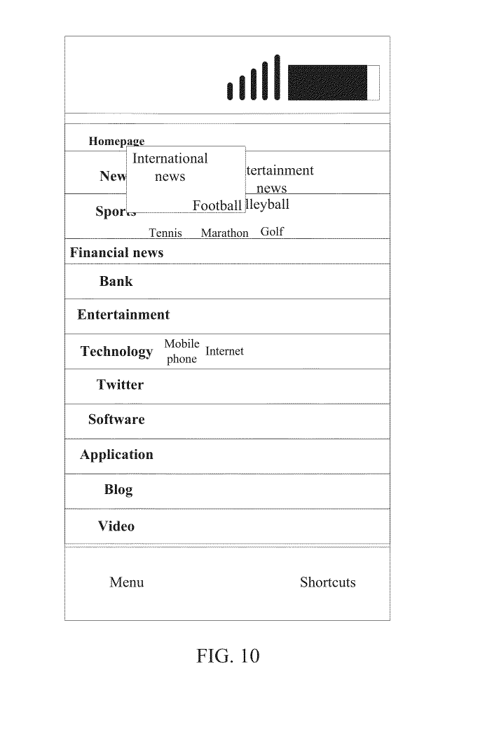

In detail, when the center of the contact range falls within the peripheral region of one icon, and the first icon adjacent to the center of the contact range and on the straight line connecting the center of the icon to the center of the contact range is selected as the object to be amplified, the terminal firstly determines the center of the contact range of the user's finger determined in step S110, and further determines whether or not the center falls within the peripheral region of one icon. If the center falls within the peripheral region of one icon, the first icon on a direction opposite to the direction from the center to the center of the one icon is found, and the one icon and the first icon are simultaneously selected as the icons needed to be amplified and displayed in the amplification region. As shown in FIG. 9, which is the schematic view of how to determine the icons needed to be amplified, the center of the contact range of the user is in the point 91. According to analyzation, the point 91 just falls within the gray peripheral region of the icon of international news, thus the terminal determines a straight line connecting the icon center 92 of the icon of international news to the point 91, and determines that the first icon on the reverse extension line of the straight line is the icon of football, thus the icon of international news and the icon of football are selected as the icons needed to be amplified in the amplification region. The amplification effect is shown in FIG. 10. The amplification region of FIG. 10 includes the icon of international news on the center of the contact range of the user and the first icon, that is the icon of football, on the reverse extension line of the straight line connecting the center of the icon of international news to the center of the contact range. All of the two icons may be directly triggered in the amplification region, and corresponding instructions are executed. When the embodiment of the present invention uses this method to select the icons to be amplified, the number is not limited to two. When the size of the icons in the display interface displayed on the touchscreen is small, the number of the selected icons may be properly adjusted.

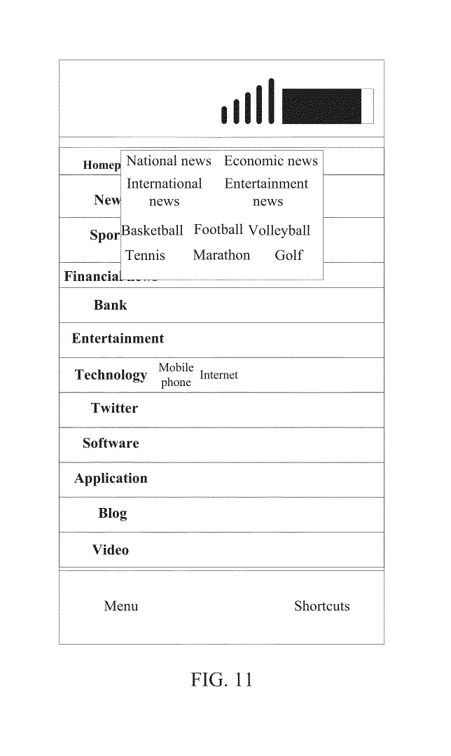

In detail, when the terminal selects the icons at least a part of each of which falls within the second specified range the center of which is the same as that of the contact range as the objects to be amplified, the terminal firstly determines the center of the contact range of the user's finger determined in step S110, and then determines the second specified range, for example determines the icons at least a part of each of which falls within the second specified range. The shape and size of the second specified range may be default, or may be specifically set according to actual condition. For example, as shown in FIG. 7, the terminal sets the center of the contact range of the user's finger obtained in step S110 as the center of the second specified range, and sets the second specified range including the icons needed to be amplified to be a rectangle the center of which is the same as that of the contact range, and the length and the width of which are respectively 30 mm and 18 mm, thus the terminal may select eight icons of domestic news, economic news, international news, entertainment news, basketball, football, volleyball, marathon, tennis, and golf as the icons to be amplified in the amplification region. At this point the display effect on the display interface displayed on the terminal is shown in FIG. 11. The terminal generates the amplification region, and displays all the icons obtained in step S110 in the amplification region. All of these icons may be directly triggered in the amplification region, and corresponding instructions are executed. The second specified range in this embodiment of the present invention may include the first specified range.

In detail, when the terminal selects the third specified range the center of which is the same as that of the contact range as the object to be amplified, the terminal firstly determines the center of the contact range of the user's finger determined in step S110, and then determines the third specified range. The shape and size of the third specified range may be default, or may be set according to actual condition. For example, the terminal sets the center of the contact range of the user's finger obtained in step S110 as the center of the third specified range, and sets the third specified range including the icons needed to be amplified to be a rectangle the center of which is the same as that of the contact range, and the length and the width of which are respectively 30 mm and 18 mm, thus the selected range may also be the same as the selected range shown in FIG. 7, and the display effect on the display interface displayed on the terminal is shown in FIG. 11. The third specified range in this embodiment of the present invention may include the second specified range, or may be included by the second specified range.

The amplification region referred in the embodiment of the present invention may be created based on the original display interface and displayed on the top layer of the original display interface, or may be the amplification region added to the original display interface. The amplification region may be displayed close to the coverage range of the user flexibly, or may be displayed in a specified position of the display interface. The size of the amplification region may be a specified value or a default value, or may be adjusted flexibly according to the size of the display interface. For example, the proportion between the size of the amplification region and the size of the display interface may be set to be 1:1, thus the terminal in the embodiment of the present invention generates the amplification region the size of which is the same as that of the display interface.

In step S113, when it is detected that the user triggers one icon in the amplification region, responding to the triggering action, and executing an instruction corresponding to the icon. Specifically, when the terminal detects that the user performs an operation in the amplification region provided by the terminal, the terminal directly executes an instruction corresponding to the triggered icon. Wherein, if the execution instruction corresponding to the icon includes jumping to another page, the instruction corresponding to the icon is directly executed. If the instruction corresponding to the icon does not include jumping to another page, after the instruction corresponding to the icon is executed, the display interface is returned to its original proportion.

In addition, specifically, if the terminal detects that a touch operation is performed in the non-amplification region, the terminal starts and executes any one of a default instruction mode or a re-selection mode, and responds to the touch operation under the started mode.

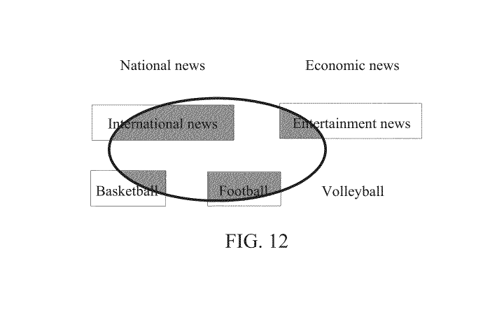

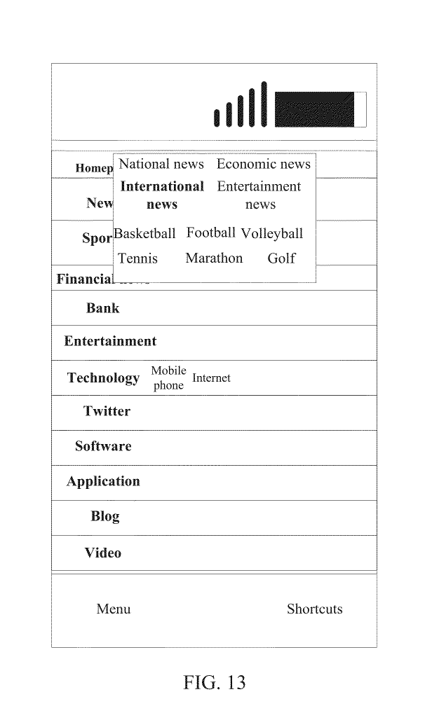

In detail, the terminal starting to execute the default instruction mode and responding to the touch operation under the started mode includes the following. The terminal determines the instruction corresponding to the icon the proportion of the coverage area of which within the contact range of the user's finger is greatest as the default execution instruction, and executes the default execution instruction. The terminal also returns the display interface to its original proportion when the default execution instruction does not include jumping to another page. Under the default instruction executing mode, when the user does not continue to perform an operation in the amplification region, the instruction corresponding to the icon the proportion of the coverage area of which within the contact range of the user's finger is greatest is executed, which may be seen from FIG. 12, which analyzes the proportion of the coverage area within the contact range of the user's finger. The figure analyzes the operation performed by the user's finger on the touchscreen which is shown in FIG. 7 referred in step S110. From FIG. 12, it may be seen that the coverage area proportion of the icon of international news is 20%, the coverage area proportion of the icon of entertainment news is 7%, the coverage area proportion of the icon of basketball is 3%, and the coverage area proportion of the icon of football is 15%. Obviously, the terminal of this step determines the execution instruction corresponding to the icon of international news the coverage area proportion of which is 20% as the default execution instruction. Also referring to FIG. 13, the schematic view showing the effect generated by the terminal automatically selecting the default execution instruction is referred. The figure shows that the terminal determines the execution instruction corresponding to the icon of international news as the default execution instruction.

In detail, the terminal starting the re-selection mode and responding to the touch operation under the started mode includes the following. The touch operation of the user's finger is recognized as a new touch operation, and a message for prompting obtaining is generated and transmitted, to cause the terminal to detect the contact range of the user's finger on the display interface again, and execute the corresponding operation process. Under the re-selection mode, the operation performed by the user in the non-amplification region is recognized as a new touch operation, and the flowchart is executed again from step S110.

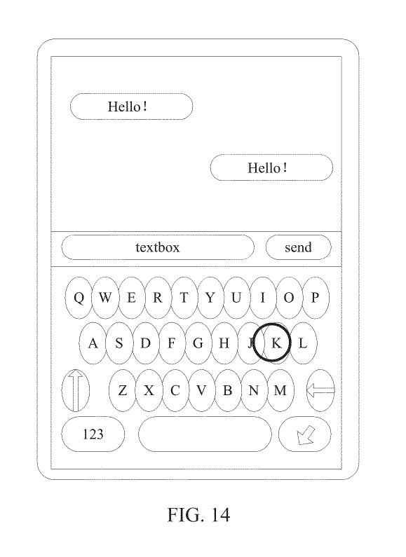

The detailed implementation in the embodiment of the present invention may also be shown in FIG. 14, which is the schematic view of inputting a text based on the terminal. The figure shows the operation performed by the user on the touchscreen when the user wants to input a text, which will be described in the following.

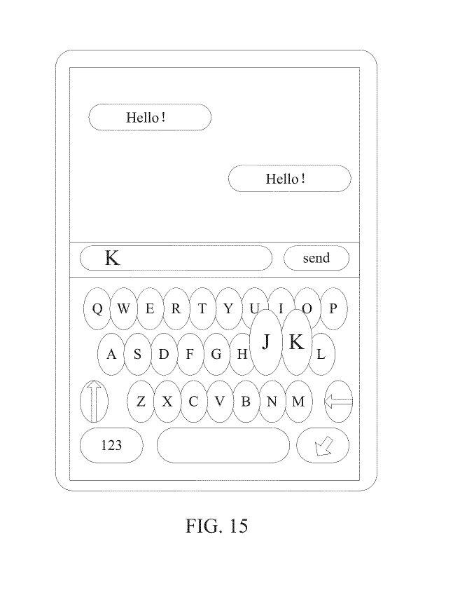

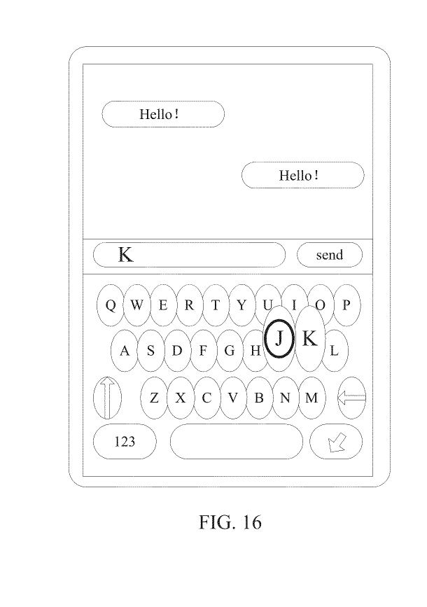

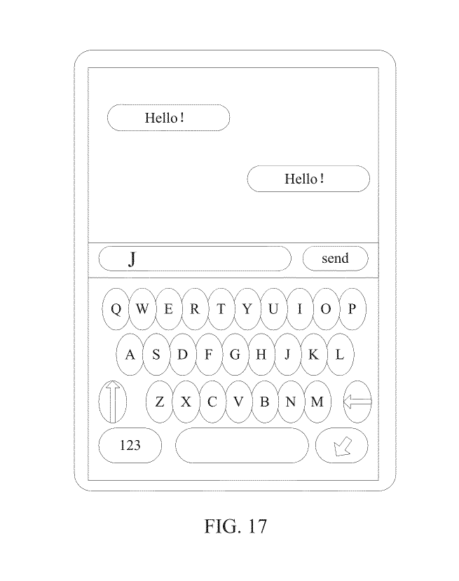

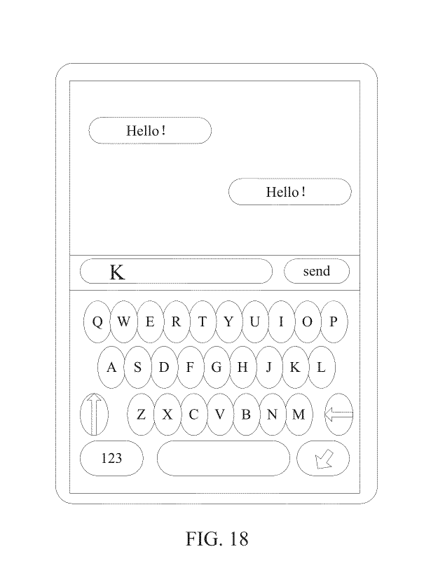

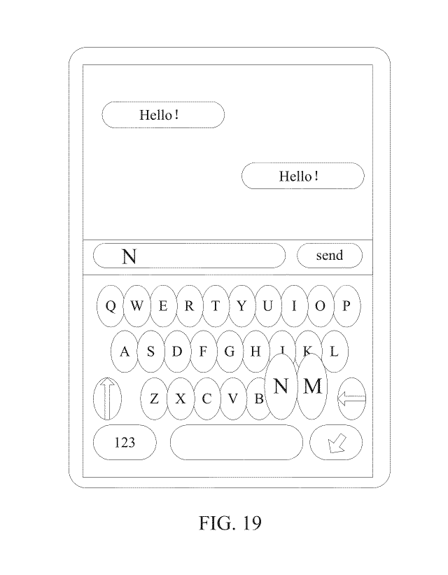

Firstly, step S110 is executed to determine that the contact range of the user's finger in the display interface is represented by the circle shown in the figure. The icon J and the desktop K at least a part of each of which falls within the contact range are obtained. Then step S111 is executed to determine that the number of the obtained icons is more than one, and the icon J and the icon K are both selected as the icon needed to be amplified based on the icon selection method of selecting all the icons at least a part of each of which falls within the contact range which is referred in step S111, and the icon J and the icon K are displayed in the amplification region, which may be seen from FIG. 15, which is the schematic view showing icon amplification effect when inputting a text based on the terminal. Finally, the subsequent operation of the user is processed according to step S112. If the terminal detects that the user directly performs a touch operation on any one of the icons of J and K displayed in the amplification region, the terminal directly executes the execution instruction corresponding to the icon, which may be seen from FIG. 16, which is the effect schematic view of inputting a text based on the terminal. Obviously, the terminal detects that the user again selects the icon J in the amplification region as the icon to be triggered, and executes the execution instruction corresponding to the icon J, which may be seen from FIG. 17, which is another effect schematic view of inputting a text based on the terminal provided. Additionally, if the terminal detects that the subsequent operation of the user is not performed in the amplification region, the terminal starts and executes any one of the default instruction mode and the re-selection mode. If the terminal starts and executes the default instruction mode, the terminal firstly analyzes that the icon the proportion of the coverage area of which within the contact range of the user's finger is greater is K, and determines the icon K as the default execution instruction, and executes the default execution instruction when the terminal detects that the user performs the touch operation in the non-amplification region, which may be seen from FIG. 18, which is another effect schematic view of inputting a text based on the terminal. In this figure, the terminal executes the default execution instruction, and inputs the letter K to the textbox. If the terminal starts the re-selection mode, when the terminal detects that the user performs a touch operation in the non-amplification region, the terminal determines that the user performs a re-selection operation, and executes step S110 again to detect the contact range of the user's finger on the display interface and obtain the icons at least a part of each of which falls within the contact range. Step S111 and step S112 are executed. As shown in FIG. 19, which is the effect schematic view of inputting a text based on the terminal, the figure shows that the user triggers the touchscreen again, and an amplification region is generated again.

In the embodiment of the present invention, when it is detected that there are a number of icons at least a part of each of which falls within the contact range of the user, an amplification region is generated on the display screen and a portion of the icons are selected to be displayed in the amplification region, to allow the user to directly perform a touch operation in the amplification region. Therefore, the embodiment of the present invention provides the user with a better operation interface, reduces the complexity of the manual operation of the user, and has utility.

Correspondingly, the embodiment of the present invention provides a terminal. The terminal may include an obtaining unit configured to obtain a contact range of an operation performed by a user on a touchscreen and icons at least a part of each of which falls within the contact range, a determining unit configured to determine whether or not the number of the obtained icons is more than one, a display unit configured to select objects to be amplified from a displayed interface displayed on the touchscreen based on the contact range and amplify the selected objects to generate an amplification region when the determining unit determines that the number of the obtained icons is more than one, a detecting unit configured to detect and obtain a further operation performed by the user on the display interface, and an executing unit to execute an instruction corresponding to one icon when the detecting unit detects that the user triggers the one icon in the amplification region. The terminal provided by the embodiment of the present invention may detect the touch operation performed by the user on the touchscreen, and generate an amplification region on the display screen when it is detected that there are a number of icons at least a part of each of which falls within the user's contact range, to provide the user with a better display interface, and reduce the complexity of the manual operation of the user.

In detail, in the embodiment of the present invention, the terminal selecting objects to be amplified includes: selecting all the icons at least a part of each of which falls within the contact range; or when the center of the contact range falls within the peripheral region of one icon, selecting the first icon adjacent to the center of the contact range and on a straight line connecting the center of the icons to the center of the contact range; or selecting the icons at least a part of each of which falls within a specified range the center of which is the same as that of the contact range. The embodiment of the present invention provides the user with the amplified icons which are displayed in the amplification region and selected by the terminal based on the contact range of the user, thus it has flexibility during use.

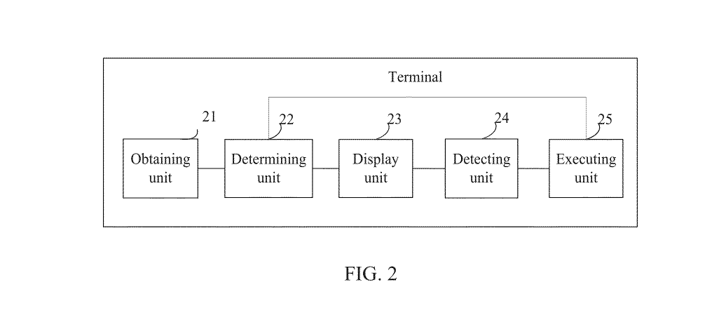

FIG. 2 is a schematic view of a structure of a terminal provided by an embodiment of the present invention. The terminal in this embodiment may be used to execute the method of FIG. 1. Specifically, the terminal in this embodiment includes an obtaining unit 21, a determining unit 22, a display unit 23, a detecting unit 24, and an executing unit 25.

Wherein, the obtaining unit 21 is configured to obtain the contact range of an operation performed by a user on the touch screen and the icons at least a part of each of which falls within the contact range. Wherein, the contact range includes the coverage range of the finger when the user performs an operation on the displayed interface displayed on the touchscreen, or the first specified range the center of which is the same as that of the coverage range. The terminal in the embodiment of the present invention is mainly the terminal with a touchscreen. Thus obtaining the contact range of the user by the obtaining unit 21 is also realized based on the interaction between software and hardware units of the touchscreen. The icons at least a part of each of which falls within the contact range are the icons displayed on the touchscreen of the terminal in the embodiment of the present invention. The icon include an image and an instruction simultaneously. This unit is configured to execute step S110, which will not be repeated herein.

The determining unit 22 is configured to determine whether the number of the icons obtained by the obtaining unit 21 is more than one.

The display unit 23 is configured to select objects to be amplified from a displayed interface displayed on the touchscreen based on the contact range and amplify the selected objects to generate an amplification region and display the amplification region on the display interface when the determining unit 22 determines that the number of the obtained icons is more than one. Wherein, selecting objects to be amplified may include: selecting all the icons at least a part of each of which falls within the contact range; or when the center of the contact range falls within the peripheral region of one icon, selecting the first icon adjacent to the center of the contact range and on a straight line connecting the center of the one icon to the center of the contact range; or selecting the icons at least a part of each of which falls within the second specified range the center of which is the same as that of the contact range; or selecting the third specified range the center of which is the same as that of the contact range. Wherein, the second specified range may include the first specified range. The third specified range may include the second specified range, or may be included by the second specified range. The displayed and amplified icon in the amplification region and provided by this unit also includes an image and an instruction. The included image is the amplified image of the image of the original icon, and the included instruction is the same as the instruction of the original icon.

The detecting unit 24 is configured to detect and obtain a further operation performed by the user on the display interface.

The executing unit 25 is configured to execute the instruction corresponding to one icon when the detecting unit 24 detects that the user triggers the one icon in the amplification region. Wherein, when the instruction corresponding to the icon includes jumping to another page, the executing unit 25 directly executes the instruction corresponding to the icon. When the instruction corresponding to the icon does not include jumping to another page, the executing unit 25 executes the instruction corresponding to the icon, and transmits a message for prompting recovery to the display unit 23.

The display unit 23 is further configured to return the display interface to its original proportion after receiving the message for prompting recovery transmitted by the executing unit 25.

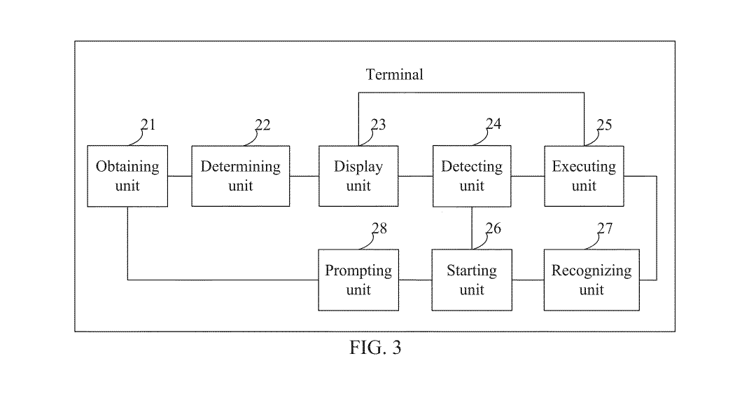

Referring also to FIG. 3, which is the schematic view of the structure of the terminal in another embodiment, the terminal in this figure further includes a starting unit 26, a recognizing unit 27, and a prompting unit 28, which are configured to process a user's further operation when the user performs a further operation in the non-amplification region of the touchscreen. When the detecting unit 24 detects that the user performs a touch operation in the non-amplification region of the touchscreen, any one of the default instruction mode and the re-selection mode is started and executed, and the touch operation is responded under the started mode.

Wherein, when the terminal starts and executes the default instruction mode and responds to the touch operation under the started mode, the starting unit 26 is configured to start and execute the default instruction mode. Wherein, under the default instruction mode, when the user does not continue to perform an operation in the amplification region, the terminal causes the executing unit 25 to execute the execution instruction corresponding to the icon the proportion of the coverage area of which within the contact range of the user's finger is greatest. The recognizing unit 27 recognizes the instruction corresponding to the icon the proportion of the coverage area of which within the contact range of the user's finger is greatest as the default execution instruction, and transmits the default execution instruction to the executing unit 25. The executing unit 25 is configured to receive and execute the default execution instruction, and transmits the message for prompting recovery to the display unit 23 when the default execution instruction does not include jumping to another page, which are referred in step S113 and will not be repeated herein.

The terminal starting the re-selection mode and responding to the touch operation under the started mode includes the following. The starting unit 26 is configured to start the re-selection mode. Wherein, under the re-selection mode, the operation performed by the user in the non-amplification region is recognized as a new touch operation. The prompting unit 28 is configured to generate and transmit a message for prompting obtaining to the obtaining unit 21. Wherein, the message for prompting obtaining is for prompting the obtaining unit 21 to again start the detecting and obtaining work. The obtaining unit 21 is further configured to detect the contact range of the user's finger on the display interface after receiving the message for prompting obtaining transmitted by the prompting unit 28, and execute the corresponding operation progress.

The terminal provided by the embodiment of the present invention detects the touch operation performed by the user on the touchscreen, and when it is detected that there are a number of icons at least a part of each of which within the contact range of the user, the terminal generates the amplification region on the display screen and selects a part of the icons to be displayed in the amplification region, to allow the user to directly perform a touch operation in the amplification region. Therefore, the embodiment of the present invention provides the user with a better operation interface, and reduces the complexity of the manual operation of the user.

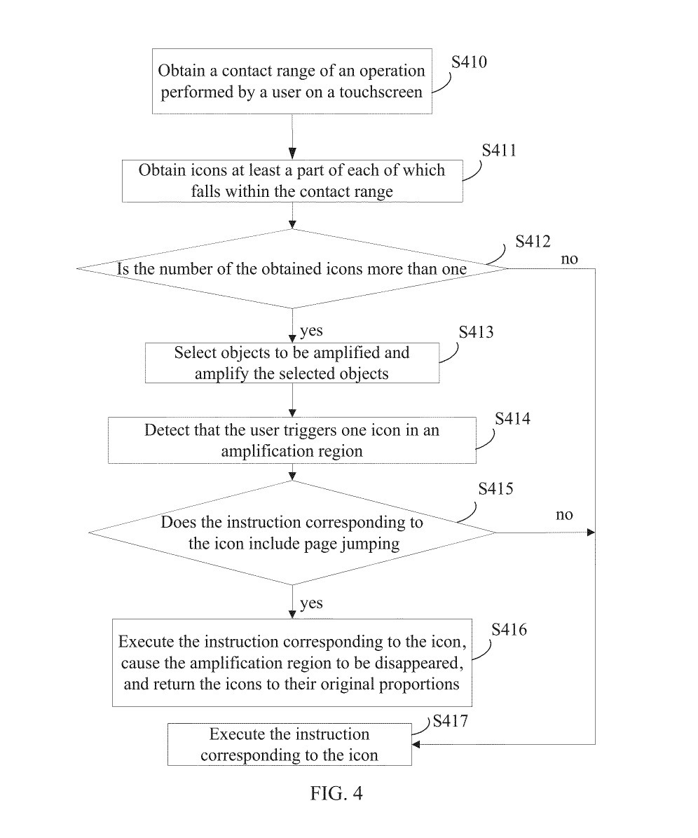

In addition, the terminal provided by the embodiment of the present invention may be realized by an application. Referring also to FIG. 4, the flowchart of the terminal provided by an embodiment of the present invention is shown. The figure shows that the terminal in the embodiment of the present invention generates an amplification region on the touchscreen when it is detected that there are a number of icons at least a part of each of which falls within the contact range of the user when the user performs a touch operation on the touchscreen, to allow the user to directly perform a touch operation on the amplified icon in the amplification region, and to allow the user to directly perform a touch operation in the amplification region. The terminal also executes the execution instruction corresponding to one icon after it is detected that the user directly performs a touch operation on the one icon in the amplification region.

In step S410, obtaining the contact range of an operation performed by the user on the touchscreen. The obtaining unit 21 finishes this step. The detailed method is referred in step S110, which will not be repeated herein.

In step S411, obtaining the icons at least a part of each of which falls within the touch control rage. The obtaining unit 21 finishes this step. The detailed method is referred in step S110, which will not be repeated herein.

In step S412, determining whether or not the number of the icons at least a part of each of which falls within the contact range is more than one. The determining unit 22 finishes this step. Furthermore, when the determining unit 22 determines that the number of the icons at least a part of each of which falls within the contact range is more than one, step S413 is executed. When the determining unit 22 determines that the number of the icons at least a part of each of which falls within the contact range is not more than one, step S417 is executed.

In step S413, selecting the objects to be amplified and amplifying the selected objects to generate an amplification region. The objects to be amplified selected in this step may include the icons and the display interface, or the icons, or the display interface. The display unit 23 finishes this step. The detailed selection and display methods are referred in step S112, which will not be repeated herein.

In step S414, detecting that one icon in the amplification region is triggered. The detecting unit 24 finishes this step.

In step S415, determining whether or not the instruction corresponding to the icon includes page jumping. When the instruction corresponding to the icon includes page jumping, step S416 is executed. When the instruction corresponding to the icon does not include page jumping, step S417 is executed.

In step S416, executing the instruction corresponding to the icon, causing the amplification region to be disappeared, and returning the icons to their original proportions.

In step S417, executing the instruction corresponding to the icon.

The terminal in the embodiment of the present invention provides the user with the amplification region and the amplified icons which may be directly touched, and may execute corresponding instructions. When the instruction does not include page jumping, the terminal causes the amplification region to be disappeared automatically, and causes the display interface to return to its original display. The terminal in the embodiment of the present invention increases the accuracy of user's operation, and has utility.

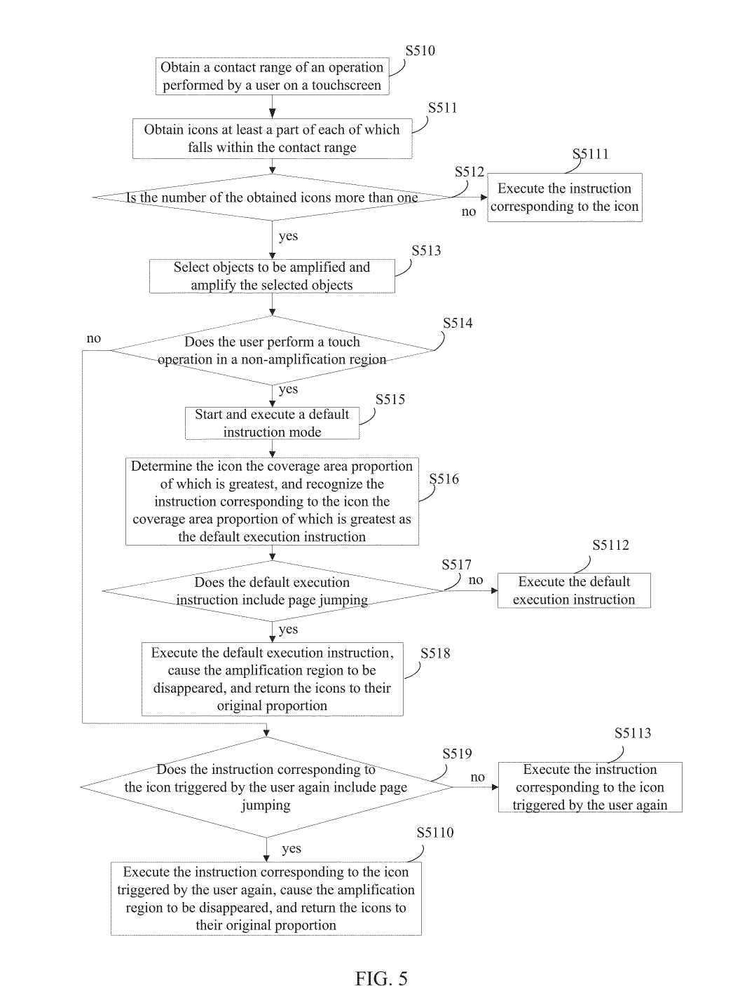

FIG. 5 is a flowchart of the terminal provided by another embodiment of the present invention. Comparing to FIG. 4, in this figure, after the terminal generates the amplification region and the amplified icons which may be directly triggered by the user, the process after the terminal detects that the user triggers one icon in the non-amplification region is added to FIG. 5. The flowchart includes the following steps.

In step S510, obtaining the contact range of an operation performed by the user on the touchscreen. The content referred in step S410 is referred, which will not be repeated herein.

In step S511, obtaining the icons at least a part of each of which falls within the contact range. The content referred in step S411 is referred, which will not be repeated herein.

In step S512, determining whether or not the number of the icons at least a part of each of which falls within the contact range is more than one. The content referred in step S412 is referred. Also, when the determining unit 22 determines that the number of the icons at least a part of each of which falls within the contact range is more than one, step S513 is executed. When the determining unit 22 determines that the number of the icons at least a part of each of which falls within the contact range is not more than one, step S5111 is executed.

In step S513, selecting the objects to be amplified and amplifying the selected objects to generate the amplification region. The content referred in step S413 is referred, which will not be repeated herein.

In step S514, detecting whether or not the user performs a touch operation in the non-amplification region. The detecting unit 24 finishes this step. Additionally, if the user performs a touch operation in the non-amplification region, step S515 is executed. If the user does not perform a touch operation in the non-amplification region, step S518 is executed.

In step S515, starting and executing the default instruction mode. Wherein, under the default execution instruction, when the user does not continue to perform an operation in the non-amplification region, the terminal causes the executing unit 25 to execute the instruction corresponding to the icon the proportion of the coverage area of which within the contact range of the user's finger is greatest. After the terminal starts and executes the default instruction mode, then subsequent process will be processed according to indications generated by executing the default instruction mode.

In step S516, determining the icon the coverage area proportion of which is greatest, and determining the instruction corresponding to the icon the coverage area proportion of which is greatest as the default execution instruction. The determining unit 27 finishes this step.

In step S517, determining whether or not the default execution instruction includes page jumping. Wherein, if the instruction corresponding to the icon includes page jumping, step S518 is executed. If the instruction corresponding to the icon does not include page jumping, step S5112 is executed.

In step S518, executing the default execution instruction, causing the amplification region to be disappeared, and returning the icons to their original proportions.

In step S519, determining whether or not the instruction corresponding to one icon triggered by the user again includes page jumping. Wherein, if the instruction corresponding to the icon triggered by the user again includes page jumping, step S518 is executed. If the instruction corresponding to the icon triggered by the user again does not include page jumping, step S5113 is executed.

In step S5110, executing the instruction corresponding to the icon triggered by the user again, causing the amplification region to be disappeared, and returning the icons to their original proportions.

In step S5111, executing the instruction corresponding to the icon.

In step S5112, executing the default execution instruction.

In step S5113, executing the instruction corresponding to the icon triggered by the user again.

The terminal in the embodiment of the present invention provides the user with the amplification region and the amplified icons which may be directly touched, and provides the default instruction execution mode when it is detected that the user does not perform a touch operation in the amplification region provided by the terminal, causing the terminal to execute the user's touch operation under a specified mode. The terminal in the embodiment of the present invention improves the process of the user's subsequent touch operation, increases the accuracy of user's operation, and has utility.

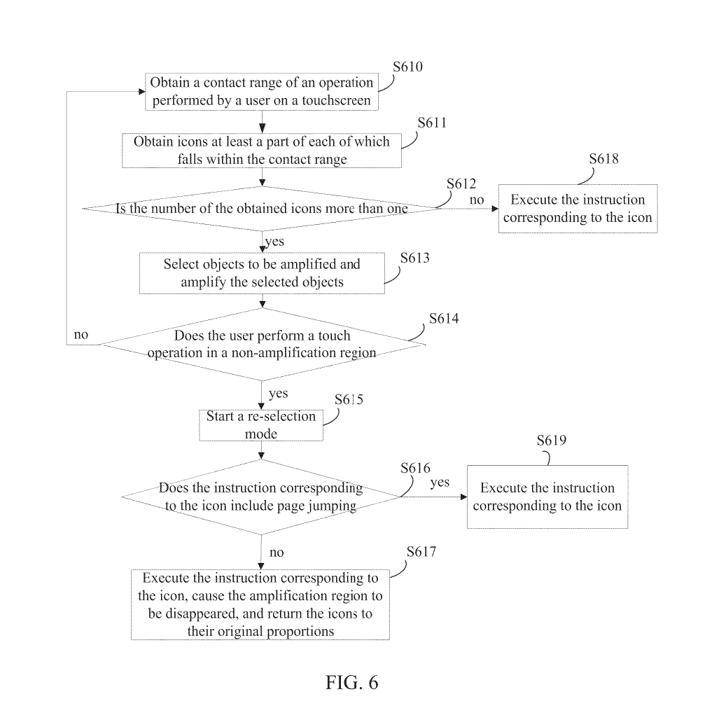

FIG. 6 is a flowchart of the terminal provided by another embodiment of the present invention. Comparing to FIG. 4, in this figure, after the terminal generates the amplification region and the amplified icons which may be directly triggered by the user, the process after the terminal detects that the triggers one icon in the non-amplification region is added to FIG. 6. The flow chart includes the following steps.

In step S610, obtaining the contact range of an operation performed by the user on the touchscreen. The content referred in step S510 is referred, which will not be repeated herein

In step S611, obtaining the icons at least a part of each of which falls within the contact range. The content referred in step S511 is referred, which will not be repeated herein.

In step S612, determining whether or not the number of the icons at least a part of each of which falls within the contact range is more than one. The content referred in step S512 is referred. Also, when the determining unit 22 determines that the number of the icons at least a part of each of which falls within the contact range is more than one, step S613 is executed. When the determining unit 22 determines that the number of the icons at least a part of each of which falls within the contact range is not more than one, step S618 is executed.

In step S613, selecting the objects to be amplified, and amplifying the selected objects to generate the amplification region. The content referred in step S613 is referred, which will not be repeated herein.

In step S614, detecting whether or not the user performs a touch operation in the non-amplification region. The detecting unit 24 finishes this step. Additionally, if the user performs a touch operation in the non-amplification region, step S615 is executed. If the user does not perform a touch operation in the non-amplification region, step S616 is executed.

In step S615, starting the re-selection mode. Wherein, under the re-selection mode, the operation performed by the user in the non-amplification region is recognized as a new touch operation. After executing this step, the procedure returns to step S610.

In step S616, determining whether or not the instruction corresponding to the icon includes page jumping. Wherein, when the instruction corresponding to the icon includes page jumping, step S617 is executed. When the instruction corresponding to the icon does not include page jumping, step S618 is executed.

In step S617, executing the instruction corresponding to the icon, causing the amplification region to be disappeared, and returning the icons to their original proportions.

In step S618, executing the instruction corresponding to the icon.

In step S619, executing the instruction corresponding to the icon.

The terminal in the embodiment of the present invention provides the user with the amplification region and the amplified icons which may be directly touched, and provides a re-selection mode when it is detected that the user does not perform a touch operation in the amplification region provided by the terminal, causing the terminal to execute the user's touch operation under a specified mode. The terminal in the embodiment of the present invention improves the process of the user's subsequent touch operation, increases the accuracy of user's operation, and has utility.

When it is detected that the number of the icons covered by the user's finger is more than one, the terminal provided by the embodiment of the present invention selects objects to be amplified from the displayed interface displayed on the touchscreen based on the contact range of the user, and amplifies the selected objects to allow the user to be able to directly perform an operation in the amplification region, thus providing the user with a better operation interface. The terminal provides a number of selection methods to select the icons to be amplified, thus has utility. The function of allowing the user to directly perform a touch operation in the amplification region increases the accuracy of the user's operation, reduces the trouble brought by multiple touch operations which are caused by false touch. When the instruction corresponding to the icon does not include page jumping, the terminal automatically returns the page to its original proportion, which is convenient. The terminal may be developed or used based on a kind of software or application, and has operability and utility.

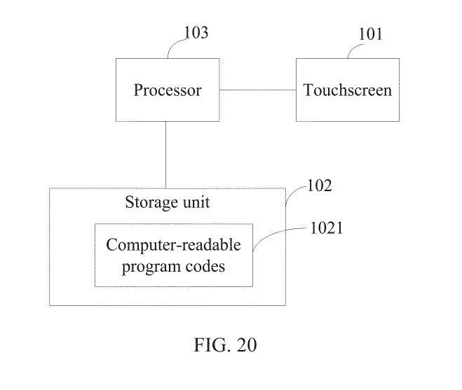

Referring to FIG. 20, it is a schematic diagram of a terminal in accordance with an exemplary embodiment of present disclosure. The terminal can include but not limited to a touchscreen 101, a storage unit 102, and a processor 103 electrically connected to the touchscreen 101 and the storage unit 102.

The storage unit 102 is configured to store a plurality of computer-readable program codes 1021. The storage unit 102 can be a read only memory (ROM), a random access memory (RAM), a U-disk, a removable hard disk, etc.

The processor 103 can include multiple cores for multi-thread or parallel processing. In this embodiment, the processor 103 is configured to execute the computer-readable program codes 1021 to obtain a contact range of an operation performed by a user on the touchscreen 101 and icons at least a part of each of which falls within the contact range, determine whether or not the number of the obtained icons is more than one, select objects to be amplified from a display interface displayed on the touchscreen 101 based on the contact range and amplify the selected objects to generate an amplification region if the number of the obtained icons is more than one, and execute an instruction corresponding to one icon when it is detected that the user triggers the one icon in the amplification region.

In this embodiment, the contact range includes the coverage range of a finger when the user performs the operation on the display interface displayed on the touchscreen 101, or a first specified range the center of which is the same as that of the coverage range.

In this embodiment, selecting the objects to be amplified by the processor 103 may include: selecting all the icons at least a part of each of which falls within the contact range; or when the center of the contact range falls within the peripheral region of one icon, selecting the first icon adjacent to the center of the contact range and on a straight line connecting the center of the one icon to the center of the contact range; or selecting the icons at least a part of each of which falls within a second specified range the center of which is the same as that of the contact range; or selecting a third specified range the center of which is the same as that of the contact range. Additionally, when the selected icons are amplified according to a specified proportion, the amplification proportion may be a default value, or may be specifically set. Additionally, the amplification region of the display interface may be on a position near the touch position of the user, or the display interface may be directly amplified with the current touch position as the center. The area of the amplification region may be set to just include all the amplified icons, or may be adjusted according to specific condition.

In this embodiment, if the instruction corresponding to the icon is jumping to another page, the processor 103 is configured to execute the computer-readable program codes 1021 to execute the instruction. If the instruction corresponding to the icon is not jumping to another page, after the instruction is executed, the processor 103 is configured to execute the comupter-reable program codes 1021 to return the display interface to its original proportion.

In this embodiment, the processor 103 is further configured to execute the computer-readable program codes 1021 to start and execute any one of a default instruction mode and a re-selection mode when it is detected that the user performs an operation in a non-amplification region. In this embodiment, starting and executing the default instruction mode and executing the instruction corresponding to the icon during executing the default instruction mode by the processor 103 may include: recognizing the instruction corresponding to the icon the proportion of the coverage area of which within the contact range of the user's finger is greatest as the default execution instruction, and executing the default execution instruction and returning the display interface to its original proportion when the default execution instruction does not comprise jumping to another page.

In this embodiment, starting the re-selection mode and execute the instruction corresponding to the icon during executing the re-section mode by the processor 103 may include: recognizing the touch operation of the user's finger as a new touch operation, generating and transmitting a message for prompting obtaining, to cause the terminal to check the contact range of the user's finger on the display interface again, and execute corresponding operation process.

In this embodiment, when it is detected that the number of the icons covered by the user's finger is more than one, the terminal provided by the embodiment of the present invention selects objects to be amplified from the displayed interface displayed on the touchscreen 101 based on the contact range of the user, and amplifies the selected objects to allow the user to be able to directly perform an operation in the amplification region, thus providing the user with a better operation interface. The terminal provides a number of selection methods to select the icons to be amplified, thus has utility. The function of allowing the user to directly perform a touch operation in the amplification region increases the accuracy of the user's operation, reduces the trouble brought by multiple touch operations which are caused by false touch. When the instruction corresponding to the icon does not include page jumping, the terminal automatically returns the page to its original proportion, which is convenient. The terminal may be developed or used based on a kind of software or application, and has operability and utility.

The terminal in the embodiment of the present invention may be a mobile phone, a PDA (PDA, Personal Digital Assistant), or a tablet computer.

The units or sub-units in all embodiments of the present invention can be realized by a universal integrated circuit, such as a CPU (Central Processing unit, CPU) for example, or by an ASIC (Application Specific Integrated Circuit, ASIC).

One of ordinary skill in the art can understand that all or part of process can be accomplished by using a computer program to instruct related hardware. All the program can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

The embodiments described above are merely preferred ones of the present disclosure but are not limitations to the protection scope of the present disclosure, thus equivalent variations made according to the appended claims of the present invention still fall within the scope of the present invention.

What is claimed is:

1. A method for controlling a terminal with a touchscreen, comprising:
obtaining a contact range of an operation performed by a user on a touchscreen and icons at least a part of each of which falls within the contact range;
determining whether or not the number of the obtained icons is more than one;
selecting objects to be amplified from a display interface displayed on the touchscreen based on the contact range and amplifying the selected objects to generate an amplification region if the number of the obtained icons is more than one; and
executing an instruction corresponding to one icon when it is detected that the user triggers the one icon in the amplification region.

2. The method of claim 1, wherein the contact range comprises the coverage range of a finger when the user performs the operation on the display interface displayed on the touchscreen, or a first specified range the center of which is the same as that of the coverage range.

3. The method of claim 1, wherein the step of selecting the objects to be amplified comprises:
selecting all the icons at least a part of each of which falls within the contact range; or
selecting the first icon adjacent to the center of the contact range and on a straight line connecting the center of one icon to the center of the contact range when the center of the contact range falls within the peripheral region of the one icon; or
selecting the icons at least a part of each of which falls within a second specified range the center of which is the same as that of the contact range; or
selecting a third specified range the center of which is the same as that of contact range.

4. The method of claim 1, wherein if the instruction corresponding to the icon is jumping to another page, the instruction is executed; if the instruction corresponding to the icon is not jumping to another page, after the instruction is executed, the display interface is returned to its original proportion.

5. The method of claim 1, wherein if the terminal detects that the user performs an operation in a non-amplification region, the terminal starts and executes any one of a default instruction mode and a re-selection mode, starting and executing the default instruction mode and executing the instruction corresponding to one icon during executing the default instruction mode by the terminal comprises:
recognizing the instruction corresponding to one icon the proportion of the coverage area of which within the contact range of the user's finger is greatest as the default execution instruction by the terminal;
executing the default execution instruction and returning the display interface to its original proportion when the default execution instruction does not comprise jumping to another page.

6. The method of claim 1, wherein if the terminal detects that the user performs an operation in a non-amplification region, the terminal starts and executes any one of a default instruction mode and a re-selection mode, starting the re-selection mode and executing the instruction corresponding to one icon during executing the re-selection mode by the terminal comprises:
recognizing the touch operation of the user's finger as a new touch operation, and generating and transmitting a message for prompting obtaining, to cause the terminal to check the contact range of the user's finger on the display interface again, and execute corresponding operation process.

7. A terminal comprising:
an obtaining unit configured to obtain a contact range of an operation performed by a user on a touchscreen and icons at least a part of each of which falls within the contact range;
a determining unit configured to determine whether or not the number of the obtained icons is more than one;
a display unit configured to select objects to be amplified from a display interface displayed on the touchscreen based on the contact range and amplify the selected objects to generate an amplification region if the number of the obtained icons is more than one;
a detecting unit configured to detect and obtain a further operation performed by a user on the display interface;
an executing unit configured to execute an instruction corresponding to one icon when the detecting unit detects that the user triggers the one icon in the amplification region.

8. The terminal of claim 7, wherein the contact range comprises the coverage range of a finger when the user performs the operation on the display interface displayed on the touchscreen, or a first specified range the center of which is the same as that of the coverage range.

9. The terminal of claim 7, wherein the step of selecting the objects to be amplified which is executed by the display unit comprises:
selecting all the icons at least a part of each of which falls within the contact range; or
selecting the first icon adjacent to the center of the contact range and on a straight line connecting the center of one icon to the center of the contact range when the center of the contact range falls within the peripheral region of the one icon; or
selecting the icons at least a part of each of which falls within a second specified range the center of which is the same as that of the contact range; or
selecting a third specified range the center of which is the same as that of the contact range.

10. The terminal of claim 7, wherein the executing unit is further configured to execute the instruction if the instruction corresponding to the icon is jumping to another page, and further configured to execute the instruction and transmit a message for prompting recovery to the display unit if the instruction corresponding to the icon is not jumping to another page; the display unit is further configured to return the display interface to its original proportion after receiving the message for prompting recovery transmitted by the executing unit.

11. The terminal of claim 8, wherein when the detecting unit detects that the user performs an operation in a non-amplification region, any one of a default instruction mode and a re-selection mode is started and executed, the terminal further comprises:
a starting unit configured to start and execute the default instruction mode;
a recognizing unit configured to recognize the instruction corresponding to one icon the proportion of the coverage area of which within the contact range of the user's finger is greatest as the default execution instruction, and transmit the default execution instruction to the executing unit;
the executing unit is further configured to receive and execute the default execution instruction, and transmit a message for prompting recovery to the display unit when the default execution instruction does not comprise jumping to another page.

12. The terminal of claim 8, wherein when the detecting unit detects that the user performs an operation in a non-amplification region, any one of the default instruction mode and the re-selection mode is started and executed;
the starting unit is configured to start the re-selection mode;
the terminal further comprises a prompting unit configured to generate and transmit a message for prompting obtaining to the obtaining unit;
the obtaining unit is further configured to check the contact range of the user's finger on the display interface after receiving the message for prompting obtaining transmitted by the prompting unit, and execute corresponding operation process.

13. A terminal comprising:
a touchscreen;
a storage unit storing a plurality of computer-readable program codes; and
a processor electrically connected to the touchscreen and the storage unit and configured to execute the plurality of computer-readable program codes to:
obtain a contact range of an operation performed by a user on the touchscreen and icons at least a part of each of which falls within the contact range;
determine whether or not the number of the obtained icons is more than one;
select objects to be amplified from a display interface displayed on the touchscreen based on the contact range and amplify the selected objects to generate an amplification region if the number of the obtained icons is more than one; and
execute an instruction corresponding to one icon when it is detected that the user triggers the one icon in the amplification region.

14. The terminal of claim 13, wherein the contact range comprises the coverage range of a finger when the user performs the operation on the display interface displayed on the touchscreen, or a first specified range the center of which is the same as that of the coverage range.

15. The terminal of claim 13, wherein the processor being configured to execute the plurality of computer-readable codes to select the objects to be amplified comprises:
selecting all the icons at least a part of each of which falls within the contact range; or
selecting the first icon adjacent to the center of the contact range and on a straight line connecting the center of one icon to the center of the contact range when the center of the contact range falls within the peripheral region of the one icon; or
selecting the icons at least a part of each of which falls within a second specified range the center of which is the same as that of the contact range; or
selecting a third specified range the center of which is the same as that of contact range.

16. The terminal of claim 13, wherein if the instruction corresponding to the icon is jumping to another page, the processor is configured to execute the plurality of computer-readable program codes to execute the instruction; if the instruction corresponding to the icon is not jumping to another page, the processor is configured to execute the plurality of computer-readable program codes to return the display interface to its original proportion after executing the instruction.

17. The terminal of claim 13, wherein the processor is further configured to execute the plurality of computer-readable program codes to start and execute any one of a default instruction mode and a re-selection mode when it is detected that the user performs an operation in a non-amplification region, the processor being configured to execute the plurality of computer-readable program codes to start and execute the default instruction mode and execute the instruction corresponding to one icon during executing the default instruction mode comprises:
recognizing the instruction corresponding to one icon the proportion of the coverage area of which within the contact range of the user's finger is greatest as the default execution instruction;
executing the default execution instruction and returning the display interface to its original proportion when the default execution instruction does not comprise jumping to another page.

18. The terminal of claim 13, wherein the processor is further configured to execute the plurality of computer-readable program codes to start and execute any one of a default instruction mode and a re-selection mode when it is detected that the user performs an operation in a non-amplification region, the processor being configured to start the re-selection mode and execute the instruction corresponding to one icon during executing the re-section mode comprises:
recognizing the touch operation of the user's finger as a new touch operation, and generating and transmitting a message for prompting obtaining, to cause the terminal to check the contact range of the user's finger on the display interface again, and execute corresponding operation process.
